(19) United States
(12) Patent Application Publication
(10) Pub. No.: US 2009/0320553 A1
(43) Pub. Date: Dec. 31, 2009

(54) Surface Measurement Probe

(75) Inventors: Nicholas John Weston, Peebles (GB); James Fergus Robertson, Hawick (GB)

Correspondence Address: OLIFF & BERRIDGE, PLC, P.O. BOX 320850, ALEXANDRIA, VA, 22320-4850, US

(73) Assignee: Renishaw PLC, Gloucestershire (GB)

(21) Appl. No.: 12/226,731

(22) PCT Filed: May 8, 2007
(86) PCT No.: PCT/GB2007/001667

§ 371 Date: Oct. 27, 2008

(30) Foreign Application Priority Data
May 8, 2006 (GB) 0608999.9

(51) Int. Cl. G01B 5/00

(52) U.S. Cl. 73/1.79; 33/561; 73/1.82

(57) ABSTRACT

Apparatus and method of determining drift for a surface measurement probe. The surface measurement probe has a housing, a surface contacting stylus, a vibration generator which causes vibration of the stylus, a sensing device for determining a parameter related to change in vibration of the stylus, and a comparator for determining the relationship of the parameter with a threshold. Readings of the parameter are taken when the stylus is not in contact with a surface and average over a time t, which is significantly larger than the transition time when touching a surface. The average of the readings of the parameter is compared to a reference parameter. The comparison is used to determine whether there has been significant drift of the parameters. Thus drift due to temperature change is corrected.

The present invention relates to a surface measurement probe. In particular the invention relates to a probe having a transducer which converts an electrical signal into a vibration, such that a stylus of the probe can thereby by vibrated. A change in the characteristic mode of the stylus vibration is used to determine whether the stylus is in contact with a surface. The surface measurement probe may be mounted on a coordinate positioning machine. In particular it is suitable for mounting on a manual coordinate positioning apparatus such as a manual coordinate positioning machine (CMM) or a manual articulating measuring arm.

British Patent Application No. GB 2006435 discloses a surface measurement probe with a workpiece contacting stylus. The probe is provided with a driving transducer and generating transducer which both comprise piezoelectric crystals. An alternating current is applied to the driving transducer to produce vibrations which are in turn transmitted to the stylus. Vibrations of the stylus excite the generating transducer. If the stylus makes contact with the surface, the vibrations are reduced. This reduction in vibration is sensed from a change in parameters of the generating transducer. Thus it may be determined when the stylus comes into contact with the surface.

U.S. Pat. No. 5,247,751 discloses a touch probe which is provided with an ultrasonic horn which has a piezoelectric element sandwiched between electrodes. The piezoelectric element converts an RF electrical signal into ultrasonic vibration. The probe is provided with a feeler which is brought into contact with an object to be measured. The horn is ultrasonically vibrated in accordance with the ultrasonic vibration of the piezoelectric element. The current between the electrodes is monitored and a change in the current value indicates a touch between the object to be measured and the feeler.

A first aspect of the present invention provides a method of determining drift for a surface measurement probe, the surface measurement probe having a housing, a surface contacting stylus, a vibration generator which causes vibration of the stylus, a sensing device for determining a parameter related to change in vibration of the stylus, and a comparator for determining the relationship of the parameter with a threshold, the method comprising the following steps in any suitable order:
Taking readings of the parameter when the stylus is not in contact with a surface;
Averaging the readings of the parameter over a time t, which is significantly larger than the transition time when touching a surface;
Comparing the average of the readings of the parameter to a reference parameter;
Using the comparison to determine whether there has been significant drift of the parameters.

The transition time is the time taken for the probe to detect a transition from the stylus contacting free space and a surface.

This method has the advantage that a change in parameters due to drift can be differentiated from a change in parameters due to contact of the stylus with a surface.

The parameter may comprise a phase change between drive voltage for the vibration generator and current passing through the generator. Alternatively, the parameter may comprise the following: The amplitude of the current passing through the piezos in a system which runs with constant voltage amplitude; the amplitude of the voltage developed across the piezos in a system which runs with constant current amplitude; the power dissipated by the piezos; or the power factor of the system supplying the piezos.

The vibration generator may comprise one or more piezoelectric elements.

Preferably the method includes a step for compensating for drift of the parameter. This step may include adjusting the drive frequency. Alternatively, the step may include adjusting the threshold.

A second aspect of the present invention provides a surface measurement probe comprising:
a housing;
a surface contacting stylus;
a vibration generator which causes vibration of the stylus;
a sensing device for determining a parameter related to change in vibration of the stylus;
a comparator for determining the relationship of the parameter with a threshold;
and a processor for carrying out the following steps in any suitable order:
Taking readings of the parameter when the stylus is not in contact with a surface;
Averaging the readings of the parameter over a time t, which is significantly larger than the transition time when touching a surface;
Comparing the average of the readings of the parameter to a reference parameter;
Using the comparison to determine whether there has been significant drift of the parameters.

The processor may carry out the additional step of using the measure of drift to adjust the behaviour of the vibration generator in order to compensate for the effect of drift on the parameter.

A third aspect of the present invention provides a surface measurement probe, the surface measurement probe comprising:
a housing;
a surface contacting stylus;
a vibration generator which causes vibration of the stylus means for determining a parameter related to change in vibration of the stylus;
and means for determining the relationship of the parameter with a threshold;
wherein the voltage generator kept at constant temperature to prevent drift of the parameter due to thermal effects.

In a preferred embodiment the vibration generator comprises one or more piezoelectric elements.

The vibration generator may be kept at a constant temperature by placing it within an oven or temperature controlled environment. This allows the effects of drift in vibration characteristics to be removed by maintaining the temperature of the key vibrating components at a constant value (either at ambient temperature or at a fixed temperature above the ambient temperature).

A third aspect of the invention provides a method of determining whether a surface measurement probe is providing reliable results, the surface measurement probe having a housing, a surface contacting stylus, a vibration generator which causes vibration of the stylus, a sensing device for determining a parameter related to change in vibration of the stylus, and a comparator for determining the relationship of the parameter with a threshold, the method comprising:
Sensing a probe variable, the variable being sensitive to accelerations of the probe;
Comparing the probe variable with a threshold;
Generating an output if the probe variable exceeds the threshold.

This method thereby determines whether the probe has stopped performing reliably due to receiving an acceleration above a threshold, due to being dropped or knocked for example.

The variable may comprise the parameter related to change in vibration of the stylus, for example a phase change between drive voltage for the vibration generator and current passing through the generator. The variable may comprise the voltage of the vibration generator or a force experienced by the probe.

The output may be a visual or audio signal. The output may be sent to a controller or PC via a communications link.

The method may include the step of resetting the probe in the event of an output, for example by performing a frequency sweep of the vibration generator. The frequency sweep may be completed automatically on receiving an output.

A fourth aspect of the present invention provides a surface measurement probe comprising:
a housing;
a surface contacting stylus;
a vibration generator which causes vibration of the stylus;
a sensing device for determining a parameter related to change in vibration of the stylus;
a comparator for determining the relationship of the parameter with a threshold;
and a processor for carrying out the following steps in any suitable order:
Sensing a probe variable, the variable being sensitive to accelerations of the probe;
Comparing the probe variable with a threshold;
outputting an output if the probe variable exceeds the threshold.

A fifth aspect of the present invention provides a surface measurement probe comprising:
a housing;
a surface contacting stylus;
a vibration generator which causes vibration of the stylus;
a sensing device for determining a parameter related to change in vibration of the stylus;
a comparator for determining the relationship of the parameter with a threshold;
a heat source which provides heat to the vibration generator; and
a temperature controller which controls the heat source, so that the vibration generator is kept at constant temperature.

The heat source may provide cooling as well as heating. A temperature transducer may be provided to measure the temperature of the vibration generator. Temperature feedback may be provided from the temperature transducer to the temperature controller. Alternatively, the temperature controller may receive an input relating to the parameter, for example phase.

The invention will now be described, by way of example, with reference to the accompanying drawings in which:

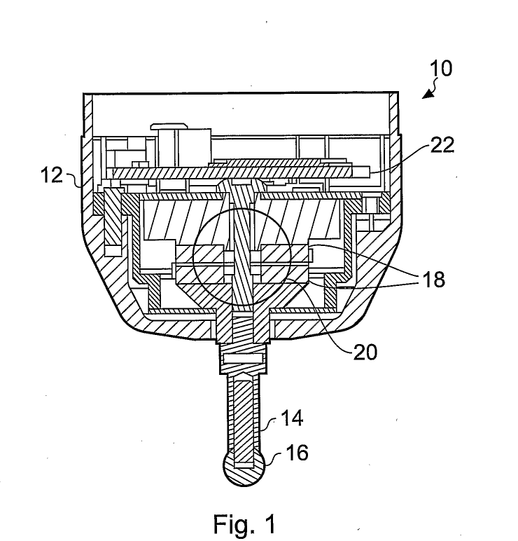

FIG. 1 is a cross section of the probe of the present invention;

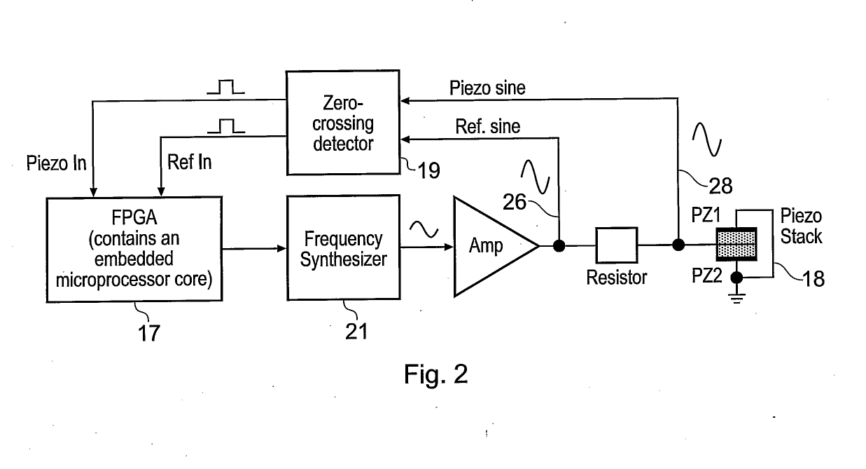

FIG. 2 illustrates a circuit diagram illustrating the internal workings of the probe of FIG. 1;

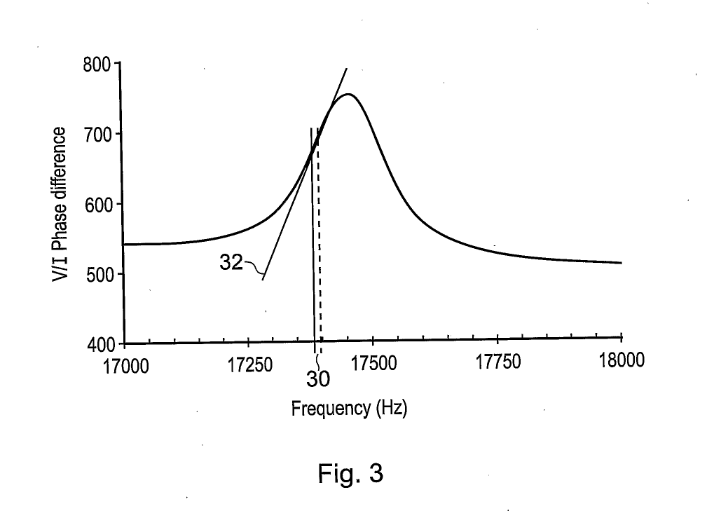

FIG. 3 is a graph illustrating measured phase difference verses drive frequency of the probe;

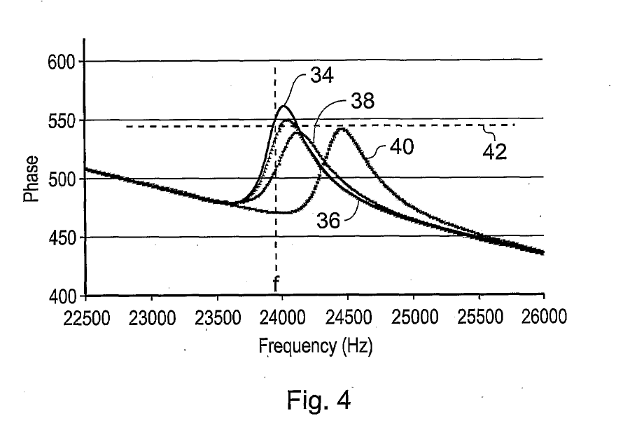

FIG. 4 is a graph illustrating measured phase difference verses drive frequency when the probe is in contact with different materials;

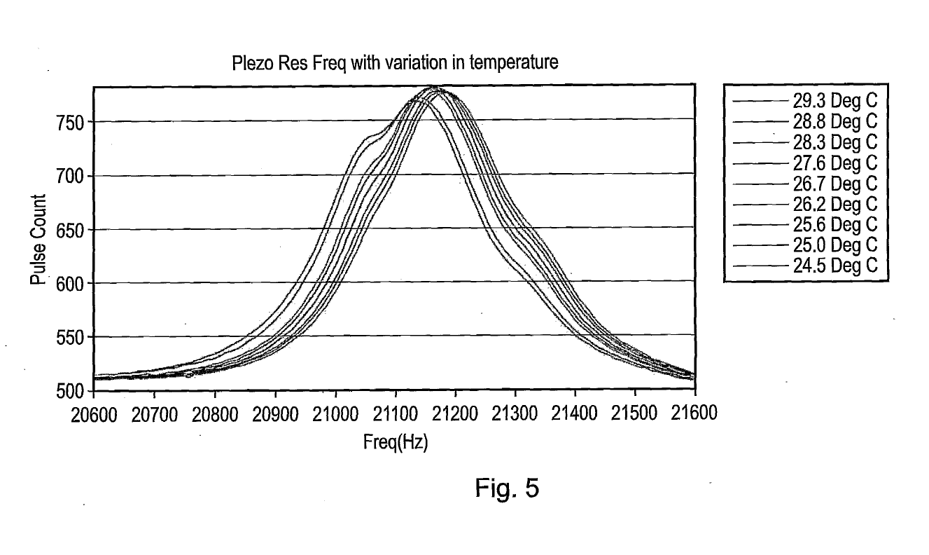

FIG. 5 is a graph illustrating measured phase difference verses drive frequency showing temperature variation;

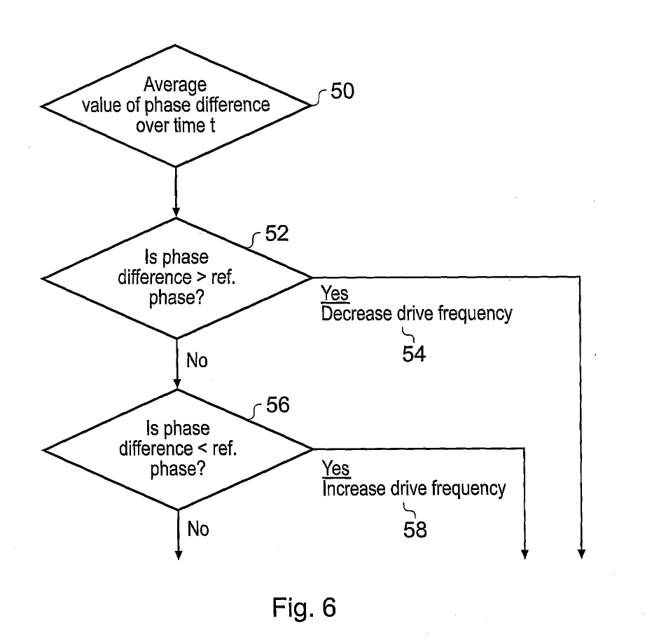

FIG. 6 is a flow diagram illustrating a thermal temperature compensation loop;

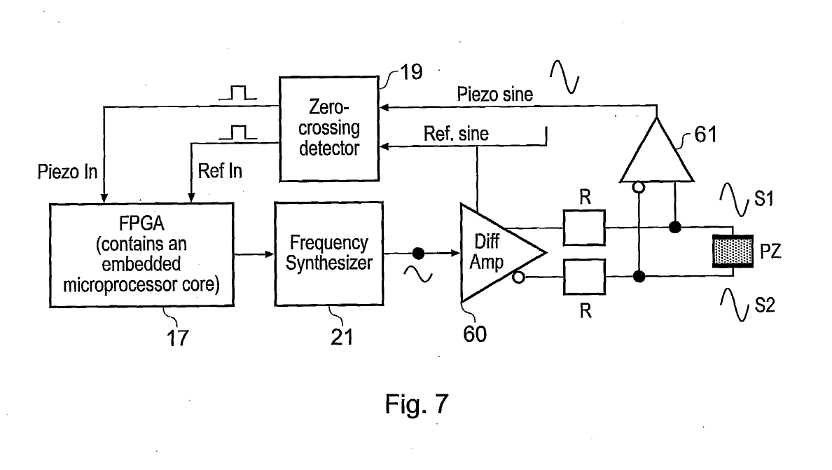

FIG. 7 illustrates an alternative circuit diagram to that illustrated in FIG. 2, having only one Piezo electric element;

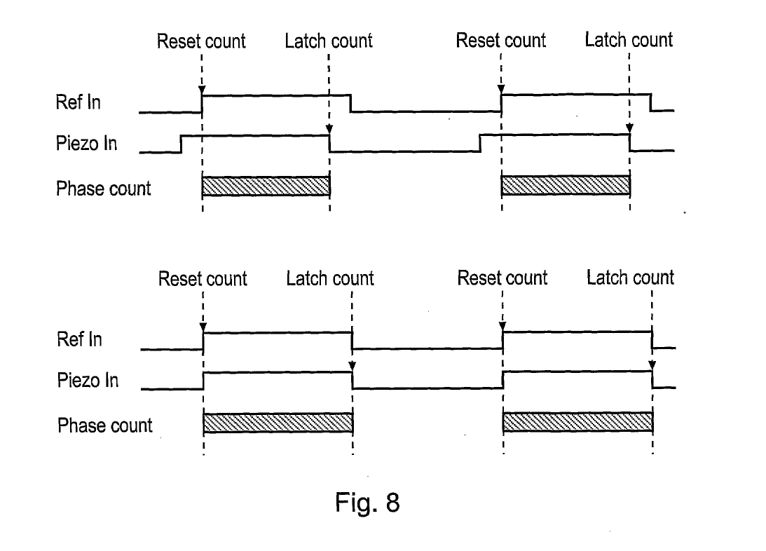

FIG. 8 illustrates the determination of the phase count from the Ref In and Piezo In signals; and

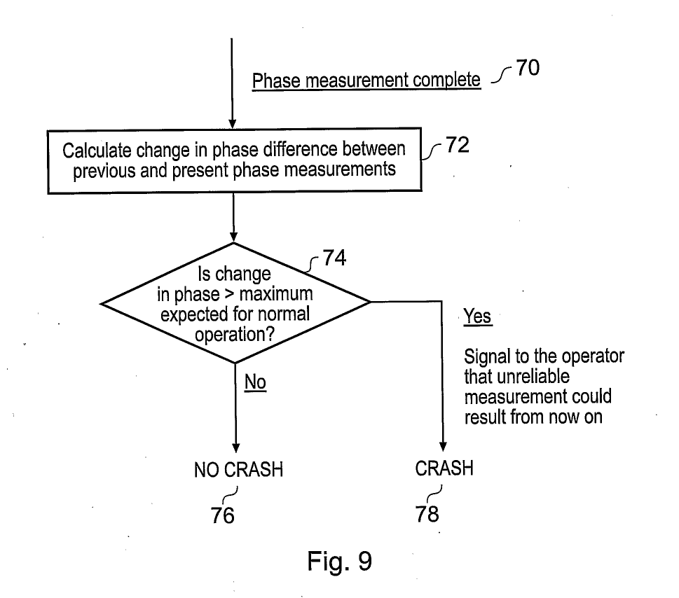

FIG. 9 is a flow diagram illustrating the determination of a whether a crash has occurred;

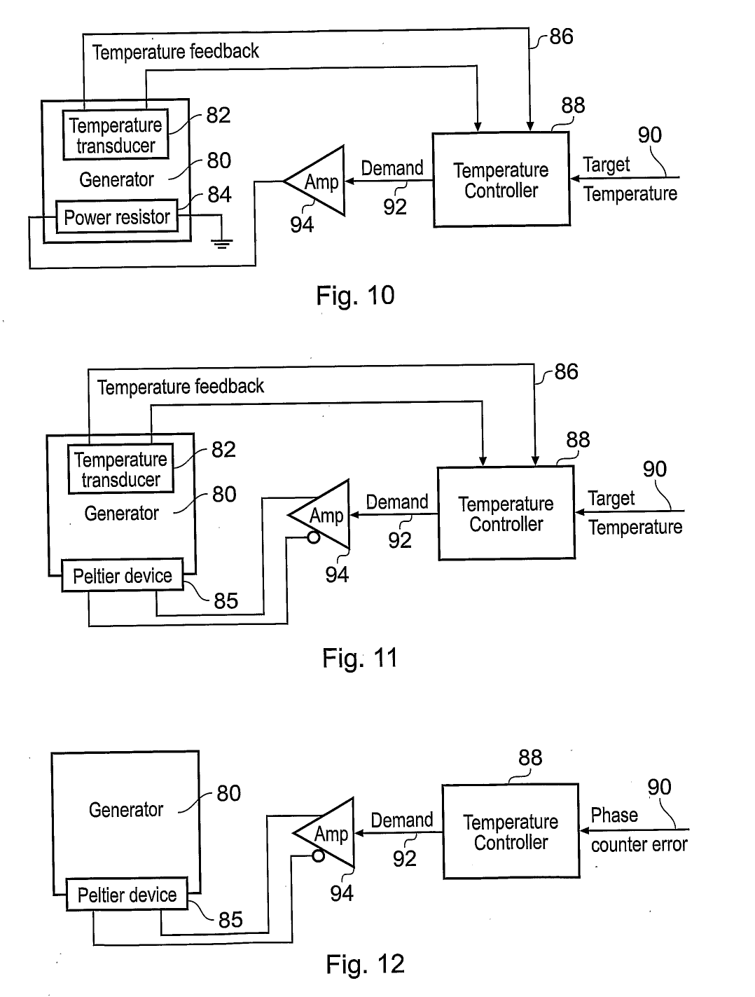

FIG. 10 is a circuit diagram of a first embodiment of a first control regime;

FIG. 11 is a circuit diagram of a second embodiment of a first control regime;

FIG. 12 is a circuit diagram of a second control regime.

FIG. 1 illustrates the probe of the present invention. The probe 10 comprises a housing 12 and a stylus 14, having a surface contacting tip 16. The probe is provided with a piezoelectric stack 18, which with a counter mass and stylus assembly forms part of a generator 20, and drive circuitry 22.

FIG. 2 is a circuit diagram illustrating the internal workings of the probe of FIG. 1. The piezoelectric stack 18 comprises two piezoelectric elements PZ1 and PZ2. An ac drive voltage ‘Ref. sine’ supplied by the drive circuitry is connected to the piezoelectric stack and causes the piezoelectric elements to vibrate. In this case the ac drive voltage is the amplified output of the frequency synthesiser 21). The drive voltage, ‘Ref. sine’, and the voltage ‘Piezo sine’, generated by the current passing through the piezoelectric elements PZ1 and PZ2 are sampled at 26 and 28 respectively. These voltages are fed into zero-crossing detectors 19 that convert the sinusoidal signals to square wave signals ‘Ref In’ and ‘Piezo In’, which are applied to the inputs of an FPGA 17. The FPGA contains an embedded microprocessor core and its internal logic produces a count in clock cycles that directly relates to the phase difference between ‘Ref. sine’ and ‘Piezo sine’. (Although FIG. 1 shows two piezoelectric elements, one or more may be used. However, two has the advantage of providing more sensitivity over one).

The piezoelectric stack is mechanically attached to the stylus of the probe, causing it to vibrate. By varying the frequency of the drive voltage, the frequency at which the stylus vibrates can be varied.

FIG. 7 illustrates an alternative arrangement of the circuit diagram in which the piezoelectric stack PZ1,PZ2 of FIG. 2 is replaced by a single piezoelectric element PZ. In this arrangement, the sine wave output from the frequency synthesiser 21 is fed into a differential amplifier 60 to produce both inverted and non-inverted drive signals. The inverted signal S1 drives one side of the piezoelectric element PZ and the non-inverted signal S2 drives the other. Each signal has a range between a maximum positive voltage and a maximum negative voltage. The piezoelectric stack PZ is polarized and, as these voltages are the inverse of each other, both sides of the polarised piezoelectric element will expand and contract at the applied frequency in a sinusoidal movement. Thus the amount of movement is similar to the stack PZ1,PZ2 described with reference to FIG. 2, in which one side of each element is driven by a unipolar drive signal and the other is grounded.

As in the stack PZ1,PZ2, the reference signal ‘Ref. sine’, is input to the zero crossing detector 19. The differential signals developed across the single piezoelectric element PZ are input to an instrumentation amplifier 61. Its output, ‘Piezo sine’, is input to the other input of the zero-crossing detector 19, as in FIG. 2. From this point onwards the processing of both ‘Ref sine’ and ‘Piezo sine’ is the same as in FIG. 2.

The advantages of using a single element are that the probe will be cheaper to produce and its length can be reduced. The disadvantages are that more electronic components are required and the element would require insulating from the probe body.

FIG. 3 illustrates a graph of phase difference against drive frequency. When power is applied, or the probe is reset, a wide frequency sweep of the piezoelectric stack is performed by varying the frequency of the drive voltage supplied by the drive circuitry. This produces the curve illustrated in FIG. 3 and allows the generator's natural frequency to be found. As shown in FIG. 3 the largest measured phase difference occurs at the resonant frequency of the probe. The frequency of the drive voltage 30 is set at the point of inflection on the gradient. This is where the gradient of the curve is at its absolute maximum 32. Both positive and negative gradients can be used as the tuning point, with consequent changes to the drift compensation mechanism. As the resonant peak is almost symmetrical the positive gradient is selected for simplicity of implementation.

When the vibrating stylus contacts a surface, the characteristic vibration mode of the stack oscillation changes and a measurable phase difference results. FIG. 4 illustrates the phase changes measured when the stylus is in contact with air 34 (i.e. in free space), plasticine 36, plastic 38 and metal 40. The measured phase difference is compared with a threshold value 42. A measured phase difference below the threshold 42 (corresponding to drive frequency f) indicates that the probe is in contact with the surface. In this case a probe output is sent to instruct the measuring arm on which the probe is mounted to take data points. In FIG. 4, the measured phase difference corresponding to drive frequency f is below the threshold value 42 when the stylus is in contact with plasticine, metal and plastic.

If the measured phase difference is above the threshold value, the stylus tip is not in contact with the surface. In FIG. 4, the measured phase difference corresponding to drive frequency f is above the threshold value when the stylus is in contact with air. In this case the probe output is disabled.

The calculation of the phase difference between the ‘Ref In’ and ‘Piezo In’ signals will now be described in more detail. The FPGA (reference number 17 in FIGS. 2 and 7) contains a master clock to which the ‘Ref. In’ and ‘Piezo In’ signals are synchronised. This master clock runs at a much higher frequency rate than the input signals.

FIG. 8 shows the ‘Ref In’ and ‘Piezo In’ signals and the phase count generated from them.

A counter in the FPGA is set to 0 on the rising edge of the ‘Ref In’ signal and increments on each master clock tick until the falling edge of the ‘Piezo In’ signal, when the count is latched. The count represents a phase difference in clock cycles, which is called the ‘phase count’. This method enables both phase advance and phase delay to be accurately measured.

As can be seen from FIG. 8, the phase count gives a measurement of the time delay, or phase difference, between the reference and the piezoelectric input signals. In particular, FIG. 8 shows the phase relationship between ‘Ref. In’ and ‘Piezo In’ signals when the piezoelectric stack is driven at a frequency away from resonance. As the ‘Ref. In’ and ‘Piezo In’ signals are indicative of voltage (V) and current (I) respectively, the measured phase difference is also termed herein the V/I phase difference.

Other aspects of the probe are described in more detail in UK Patent applications GB0608998 and GB0609022. The contents of these applications are incorporated herein by reference.

Temperature variation of the probe can cause changes in the curve illustrated in the graph in FIG. 3. Temperature variation may be caused for example by the environment, handling of the probe by an operator, and the heating effect of the vibrating piezoelectric stack and internal probe electronics. Temperature variation causes the mechanical and/or electrical characteristics of the probe to change. The temperature variation can affect the resonant frequency of the piezoelectric stack and thereby directly affect the measured phase change. If the phase difference changes relative to the fixed threshold levels the probe can appear either constantly in contact with the surface or become less sensitive. FIG. 5 illustrates a graph of pulse count (indicating phase shift) against drive frequency. The graph shows that for different temperatures the shape of resonance is maintained but there is a frequency offset.

The change in measured phase difference caused by temperature shift is a slow change wherein the change in measured phase difference due to contact of the stylus with a surface is a fast change. The difference in rate of change can be used to determine whether the change in measured phase difference is due to temperature drift or contact with a surface, as described below.

In a first step regular measurements are taken of the phase difference. The measured phase differences determined when the stylus is not in contact with the surface are averaged. The difference between the expected phase difference (i.e. as originally tuned) and the phase difference now measured (i.e. averaged over a long period compared to a surface detection measurement cycle when not in contact with the surface) is determined. A growing error between these two values shows long term drift.

By this method the temperature effect can be tracked and compensated for by increasing or decreasing the excitation frequency. For example an increase in temperature causes the curve to move to the left resulting in an increase in the measured phase difference. To maintain the drive frequency of the steepest point of the curve, the drive frequency is decreased by a small amount. For a decrease in temperature the opposite is true.

FIG. 6 illustrates a flow diagram of a thermal temperature compensation loop. These steps are carried out in the embedded microprocessor core. In a first step the average value of the phase difference over time t is determined 50. This average value is taken for values of the phase difference when the stylus is not in contact with a surface. In a second step, it is determined whether the phase difference is greater than the reference phase 52. If it is, the drive frequency is decreased 54. If the phase difference is not greater than the reference phase, it is determined whether the phase difference is less than the reference phase 56. If the phase difference is less than the reference phase the drive frequency is increased 58. This loop is repeated at regular time intervals, for example 60 ms.

One measurement cycle of the probe typically takes about 40 μs. The thermal temperature compensation loop may take 65,000 measurements. Thus if the probe remains off the surface during these 65,000 measurement (i.e. 2.6 seconds), thermal compensation will occur. As the thermal compensation loop is much greater then one measurement cycle, the change in phase difference due to surface contact will only have a small effect (particularly as the thermal compensation loop stops when the probe contacts the surface). As soon as the probe looses touch with the surface, the thermal compensation loop will re-start and any increase in phase difference due to the surface contact will be reduced. This example is for illustrative purposes and other values may be used.

As one measuring cycle is typically 40 μs, the time to detect that the probe is off the surface is equal to one measuring cycle, i.e. 40 μs. However, the time taken to detect that the probe is on surface is longer, it is 16 sequential measuring cycles, 16×40 μs=640 μs. By using 16 sequential measuring cycles, the number of false triggers is reduced. (Of course, another multiple of the measuring cycles may be used).

As an alternative to adjusting the drive frequency, other parameters may be adjusted for temperature compensation. For example the threshold value could be varied to maintain the phase relationship set at the tuned resonant frequency. For example, the threshold value may be kept at 4° from the long term value of the phase difference.

In an alternative embodiment an analogue system may be arranged in place of a digital system for compensation. Analogue elements may be connected in parallel or in series with the piezoelectric stack via a switching network to compensate for the changing electrical characteristics caused by temperature variation. These elements may have variable capacitance, inductance, and/or resistance which are used to change the component values in the circuit.

Another method of temperature compensation uses a digital phase advance/delay to compensate for the phase changes. This comprises mathematically compensating for the long term drift. For example for a phase change of 2°, a timer is started relative to the reference wave either 2° earlier or later to compensate for the drift. The timer measures the time between the reference wave and the measured wave.

The need for temperature compensating the vibration generator may be removed by keeping it at a constant temperature (the target temperature) by placing it within temperature controlled environment, such as an oven. This allows the effects of drift in vibration characteristics to be removed by maintaining the temperature of the key vibrating components at a constant value (either at ambient temperature or at a fixed temperature above the ambient temperature). A straightforward means for achieving this can be implemented by the addition of heating or cooling elements—for example power resistors (resistive elements that can safely dissipate electrical power as heat) or a Peltier device in intimate contact with the generator, and one of at least two alternative control regimes.

FIGS. 10 and 11 illustrate two embodiments of the first control regime. A temperature transducer 82 and heating element are provided in the generator 80. The heating element may just provide heating, such as the power resistor 84 in FIG. 13 or both heating and cooling, such as the Peltier device 85 in FIG. 14. Lines 86 provide temperature feedback from the temperature transducer 82, to a temperature controller 88. The temperature controller 88 receives a target temperature input 90 and uses both the target temperature 90 and temperature feedback 86 to produce a demand 92. The demand signal passes through an amplifier 94 to the heating element (e.g. power resistor 84 or Peltier device 85).

FIG. 12 illustrates the second control regime. A phase counter error 96 is input into the temperature controller 88, which outputs a demand 92. The demand signal 92 passes through an amplifier 94 to a Peltier device 85 in the generator 86. There is no requirement for the temperature transducer and temperature feedback in this regime.

The first control regime requires the temperature to be measured by attaching a thermistor, thermocouple or other temperature transducer to the key vibrating components. A servo system can then be implemented to control the current through the heating or cooling element in order to maintain a measured temperature close to the target temperature. In the case where a heating element is attached, the target temperature would have to be above normal ambient temperature as no cooling capacity is available. The choice of a temperature above ambient means that the heating current can be increased or reduced to compensate for heat input from the vibration mechanism and also changes in the amount of heat going into the device from the surroundings e.g. from the operator handling the probe or from changes in the working environment. If a Peltier device is used heating or cooling is possible. The temperature at which the probe is initialised can therefore be selected as the target temperature, meaning no warm-up time is required for the probe.

FIGS. 10 and 11 illustrate circuit diagrams of the first control regime. V vibration

The second control regime uses the measurement of phase counts to establish whether the generator vibration characteristics are drifting, instead of using a thermistor or similar to measure temperature. The drift is compensated for by having a low bandwidth current control loop (with a time constant of the same order of the thermal time constant of the generator) which uses the difference between the measured phase count and target phase count as the error signal, Phase count error, allowing the generator to cool when the phase count is too high or low and warming it up when the phase count is too low or high (the sense of the change depending upon which side of resonance the operating point is chosen to be). It is important that a low bandwidth controller is used as this type of controller can not fully compensate for rapid changes, only gradual ones. In this case, the effects of temperature drift are gradual, and the effects of the stylus contacting the surface are rapid. So a low bandwidth controller can fully compensate for temperature induced changes, but only compensates for changes caused by stylus contacts very slowly. A change in the phase count which is greater than a particular threshold indicates that the stylus is touching a surface, in which case the current feedback is held at the value prior to the large phase count change. This ensures that thermal run-away does not occur due to the current servo system trying to correct thermally what is not a thermal drift (but what is in fact due to the stylus contacting the surface) when the probe is in constant use. This method of maintaining stable operation has the advantage that the quantity of interest (the phase count when not on the surface) is that being directly controlled, and the temperature control of the generator is a side effect rather than the temperature being controlled to try and maintain a stable phase count. Most straightforwardly, the heating and cooling can be achieved in the same way as in the first control method, using a Peltier device. Where a resistive heating element is used there is no direct measure of temperature, so a warm up time is required where a base current is applied to the power resistor for a period of time before the probe can be tuned and used. This application of a known current for a known period of time, into a known thermal inertia will raise the temperature by a reasonably well defined range (depending upon variations in thermal losses), which will be within the operating temperature range of the probe.

These methods which do not adjust the value of the drive frequency have the disadvantage that enough long term drift can cause the drive frequency to no longer correspond to the steepest part of the curve. In this case the measurements become unreliable and the probe should be re-tuned. The probe may output a signal to indicate the probe needs re-tuning.

The present invention provides some crash protection for the probe. If the probe suffers a hard knock, the generator may start to vibrate in a different mode. In this state, reliable measurements cannot be obtained from the probe.

Empirical observations indicate that a large change in phase is measured over a very short period of time (e.g. microseconds) when the stylus is subjected to a hard knock; the change is much larger than could be produced from a normal surface touch on any material and far quicker than temperature drift could produce. Thus the normal measuring process can detect such an event.

Experimentation has also shown that the piezo-electric elements may be returned to their normal mode of vibration by performing a frequency sweep following a knock. This frequency sweep may be done very quickly by performing the sweep over a short range, for example over the frequency range which contains the expected highest gradient. The short sweep has the advantage of taking only a fraction of a second, whereas a full sweep would typically take a few seconds. Thus the short sweep can be performed in the time it takes for an operator to pick up the probe.

A hard knock can be detected by monitoring the generator's output. When piezoelectric elements are subjected to a force, large voltages can be generated for a short period of time. By monitoring this voltage, a knock can be sensed and reported.

Alternatively, an accelerometer or other device that measures a change in force can be used to detect and report a hard knock.

A hard knock can also be detected by monitoring the phase difference. FIG. 9 shows a flow diagram illustrating the steps in determining if the probe has suffered a hard knock. This method is carried out in the embedded microprocessor in the FPGA 17 illustrated in FIGS. 2 and 7. In a first step the embedded microprocessor calculates the change in phase difference between the previous and present phase measurements. The change in phase difference is compared with a threshold 74. If the change in phase difference is below the threshold, no crash has occurred and the probe can continue operating. If the change in phase difference is above the threshold (i.e. the maximum expected phase difference for normal operation), a crash has occurred and action should be taken. The action may comprise a signal, such as a visual or audio output (e.g. flashing light) to indicate that a crash has occurred. Alternatively, the probe may send an output to an external computer or controller via a communications link, indicating that the measurements are no longer reliable. The user is thus alerted of the crash and can manually reset the probe, for example by cycling the power or performing a re-tune.

Alternatively, the probe can automatically re-tune itself if it detects a crash. It may be set to either do a full frequency sweep or a short sweep.

1.-9. (canceled)

10. A method of determining whether a surface measurement probe is providing reliable results, the surface measurement probe having a housing, a surface contacting stylus, a vibration generator which causes vibration of the stylus, a sensing device for determining a parameter related to change in vibration of the stylus, and a comparator for determining the relationship of the parameter with a threshold, the method comprising:
Sensing a probe variable, the variable being sensitive to accelerations of the probe;
Comparing the probe variable with a threshold to determine whether the probe has accelerated above a threshold acceleration level;
Generating an output if the probe variable exceeds the threshold.

11. A method according to claim 10 wherein the variable comprises the parameter related to change in vibration of the stylus.

12. A method according to claim 11, wherein the parameter comprises a phase change between drive voltage for the vibration generator and current passing through the generator.

13. A method according to claim 10 wherein the probe variable comprises the voltage of the vibration generator.

14. A method according to claim 10 wherein the probe variable comprises a force experienced by the probe.

15. A method according to claim 10 wherein the output is a visual or audio signal.

16. A method according to claim 10 wherein the output is sent to a controller or PC via a communications link.

17. A method according to claim 10 wherein the method includes the step of resetting the probe in the event of an output.

18. A method according to claim 17 wherein the probe is reset by performing a frequency sweep of the vibration generator.

19. A method according to claim 17 in which the frequency sweep is completed automatically on receiving an output.

20. A surface measurement probe comprising:
a housing;
a surface contacting stylus;
a vibration generator which causes vibration of the stylus;
a sensing device for determining a parameter related to change in vibration of the stylus;
a comparator for determining the relationship of the parameter with a threshold;
and a processor for carrying out the following steps in any suitable order:
sensing a probe variable, the variable being sensitive to accelerations of the probe;
comparing the probe variable with a threshold to determine whether the probe has accelerated above a threshold acceleration level;
generating an output if the probe variable exceeds the threshold.

21.-25. (canceled)
